(19) United States
(12) Patent Application Publication
(10) Pub. No.: US 2018/0149304 A1
(43) Pub. Date: May 31, 2018

(54) ADJUSTABLE SUPPORT STRUCTURE

(71) Applicant: NOTTINGHAM SPIRK DESIGN ASSOCIATES, Cleveland, OH (US)

(72) Inventors: Robert ALLEN, Richmond Heights, OH (US); Paul STEPHENS, Twinsburg, OH (US); William RABBITT, Chesterland, OH (US); Jason TILK, Cleveland Heights, OH (US)

(21) Appl. No.: 15/362,170

(22) Filed: Nov. 28, 2016

(51) Int. Cl. F16M 11/28; A47B 9/20; A47B 9/12; F16M 11/18

(52) U.S. Cl. CPC F16M 11/28; A47B 9/20; A47B 2200/0059; F16M 11/18; A47B 2200/0054; A47B 9/12

(57) ABSTRACT

An adjustable support structure having a telescoping assembly that is movable by a drive mechanism between a collapsed position and an extended position. The telescoping assembly may include a latching mechanism that cooperates with one or more telescopic support members to permit or restrict movement of one or more support members relative to each other, which may depend on the position of the support members as the telescoping assembly is collapsed or extended. The drive mechanism may include linkages and a catch mechanism configured to cooperate with the latching mechanism for permitting or restricting relative movement between support members, and which may enable sequential telescopic extension or retraction of the support members. The linkages may be adapted to fit within one or more of the telescopic support members, such that the linkages may support a portion of the load, and may enhance stability by restricting lateral movement within the support members.

### FIELD OF INVENTION

The present invention relates generally to an adjustable support structure, and more particularly to a support that is telescopically adjustable with a drive mechanism.

### BACKGROUND

Tables, desks, or other platforms may have one or more leg supports that are telescopically adjustable to vary the height of the platform. The adjustment of the platform leg is often manual, and requires the user to carefully balance objects on the platform, while also exerting enough force to lift the platform along with the weight of those objects. In some cases, when the adjustable leg support is telescopically extended, the support may become more unstable due to the allowance of lateral displacement between one part of the telescoping assembly relative to another part of the telescoping assembly.

### SUMMARY OF INVENTION

The present invention provides, among other things, an adjustable support structure having a telescoping assembly that is movable by a drive mechanism between a collapsed position and an extended position, which may enable improved control during the adjustment, and which may enhance the stability of the support structure.

According to one aspect, the telescoping assembly includes a latching mechanism that cooperates with one or more telescopic support members to either permit or restrict movement of one or more support members relative to each other as the telescoping assembly is collapsed or extended.

According to another aspect, the drive mechanism may include a catch mechanism configured to cooperate with the latching mechanism for permitting or restricting relative movement between support members, and which may enable sequential telescopic extension or retraction of the support members.

According to another aspect, the drive mechanism may include a plurality of linkages that are adapted to fit within one or more of the telescopic support members, such that the linkages may at least partially support a load, and may be restricted from lateral movement within the one or more telescopic support members to enhance stability.

According to another aspect, an adjustable support structure includes a telescoping assembly extending along a longitudinal axis, the telescoping assembly including an outer support member, an intermediate support member telescopically movable in the outer support member, an inner support member telescopically movable in the intermediate support member, and a latching mechanism operatively coupled to the intermediate support member. The latching mechanism may have a latch movable between a first position for securably engaging the outer support member, and a second position for releasably disengaging from the outer support member. The adjustable support structure further includes a drive mechanism drivingly coupled to the telescoping assembly for moving the telescoping assembly along the longitudinal axis between a first axial position, in which the telescoping assembly is telescopically collapsed and the latch is in its first position thereby securably engaging with the outer support member for restricting axial movement of the intermediate support member relative to the outer support member, and a second axial position, in which the telescoping assembly is telescopically extended and the latch is in its second position thereby releasably disengaging from the outer support member for allowing axial movement of the intermediate support member relative to the outer support member.

According to another aspect, an adjustable support structure includes a telescoping assembly extending along a longitudinal axis, the telescoping assembly including an outer support member; an intermediate support member telescopically movable in the outer support member; and an inner support member telescopically movable in the intermediate support member; and a drive mechanism drivingly coupled to the telescoping assembly for moving the telescoping assembly along the longitudinal axis between a first axial position, in which the telescoping assembly is telescopically collapsed, and a second axial position, in which the telescoping assembly is telescopically extended. The drive mechanism may include a plurality of linkages drivingly coupled to the inner support member, the plurality of linkages being configured to slidably move within one or more of the outer support member and the intermediate support member when the telescoping assembly is axially moved between the first axial position and the second axial position.

According to another aspect, a method of adjusting an adjustable support structure having a drive mechanism operably coupled to a telescoping assembly, the telescoping assembly including an outer support member, an intermediate support member telescopically movable in the outer support member, and an inner support member telescopically movable in the intermediate support member, the method including one or more of the following steps alone or in combination:

when the telescoping assembly is in a telescopically collapsed position, latching the intermediate support member to the outer support member with a latching mechanism operably attached to the intermediate support member, whereby the latching restricts axial movement of the intermediate support member relative to the outer support member;

moving the inner support member independent of the intermediate support member and the outer support member, wherein the inner support member is moved with the drive mechanism such that the inner support member telescopically extends in an axial direction away from the intermediate support member and the outer support member;

moving a catch mechanism with the drive mechanism, the catch mechanism being independent from the respective support members;

engaging the latching mechanism with the catch mechanism, thereby unlatching the intermediate support member from the outer support member and enabling axial movement of the intermediate support member relative to the outer support member;

after the unlatching, moving the intermediate support member independent of the outer support member, wherein the intermediate support member is moved with the drive mechanism such that the intermediate support member telescopically extends in the axial direction away from the outer support member, the intermediate support member being moved with the catch mechanism via the latch mechanism operably attached to the intermediate support member;

during the moving the intermediate support member, moving the inner support member with the drive mechanism such that the inner support member moves with the intermediate support member;

when the telescoping assembly is in a telescopically extended position, moving the intermediate support member with the drive mechanism toward the telescopically collapsed position, wherein the intermediate support member is moved with the catch mechanism via the latch mechanism operably attached to the intermediate support member, and wherein the intermediate support member is moved independent of the outer support member;

during the moving the intermediate support member, moving the inner support member with the drive mechanism such that the inner support member moves with the intermediate support member toward the collapsed position;

disengaging the catch mechanism from the latching mechanism;

latching the intermediate support member to the outer support member with the latching mechanism, whereby the latching restricts axial movement of the intermediate support member relative to the outer support member; and

moving the inner support member independent of the intermediate support member and the outer support member, wherein the inner support member is moved with the drive mechanism toward the telescopically collapsed position.

The method may further include one or more of the steps:

during the moving the inner support member from the telescopically collapsed position toward the telescopically extended position, moving a portion of the plurality of linkages to within the intermediate support member, whereby the portion of linkages disposed within the intermediate support member are axially aligned to support a load, and engage the intermediate support member to laterally constrain movement of the portion of linkages disposed in the intermediate support member; and

during the moving the intermediate support member toward the telescopically extended position, moving another portion of the plurality of linkages to within the outer support member, whereby the portion of linkages disposed within the outer support member are axially aligned to support a load, and engage the outer support member to laterally constrain movement of the portion of linkages disposed in the outer support member.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention.

FIG. 1 illustrates a perspective view of an exemplary support structure according to an embodiment of the invention, which is shown in an exemplary telescopically collapsed position.

FIG. 2 illustrates a front plan view of the support structure in FIG. 1, with an upper support member and an intermediate support member disassembled from the support structure.

FIG. 3 illustrates a perspective view of a drive mechanism of the support structure in FIG. 1 shown in a partially disassembled state.

FIG. 4A illustrates a perspective view of the intermediate support member shown in FIG. 2.

FIG. 4B illustrates a perspective view of an alternative embodiment of the intermediate support member shown in FIG. 4A.

FIG. 5 illustrates a cross-sectional view of the support structure shown in FIG. 1 taken about the line V-V of FIG. 1.

FIG. 6 illustrates a perspective view of the support structure in FIG. 1 shown in an exemplary intermediate position.

FIG. 7 illustrates a front plan view of the support structure in FIG. 6, which is shown with the upper support member disassembled from the support structure and a cutaway view of a portion of the intermediate support member.

FIG. 7A illustrates a cross-sectional view of a portion of the support structure of FIG. 6 taken about the line VII-A-VII-A of FIG. 7.

FIG. 8 illustrates a cross-sectional view of the support structure shown in FIG. 5 taken about the line VIII-VIII of FIG. 6.

FIG. 9 illustrates a perspective view of the support structure in FIG. 1 shown in an exemplary telescopically extended position.

FIG. 10 illustrates a front plan view of the support structure in FIG. 9, which is shown with a cutaway view of a portion of the upper support member and a cutaway view of a portion of the intermediate support member.

FIG. 11 illustrates a cross-sectional view of the support structure shown in FIG. 9 taken about the line XI-XI of FIG. 9.

### DETAILED DESCRIPTION

An adjustable support structure is provided having a telescoping assembly that may be movable by a drive mechanism between a collapsed position and an extended position. The telescoping assembly may include a latching mechanism that cooperates with one or more telescopic support members to permit or restrict movement of one or more support members relative to each other, which may depend on the position of the support members as the telescoping assembly is collapsed or extended. The drive mechanism may include linkages and a catch mechanism configured to cooperate with the latching mechanism for permitting or restricting relative movement between support members, and which may enable sequential telescopic extension or retraction of the support members. The linkages may be adapted to fit within one or more of the telescopic support members, such that the linkages may support a portion of the load, and may enhance stability by restricting lateral movement within the support members.

It is understood that the principles and aspects of the present invention have particular application to adjustable support mechanisms for use with tables, chairs, beds, desks, or other such platforms, and thus will be described below chiefly in this context. It is also understood, however, that principles and aspects of this invention may be applicable to adjustable support structures for other applications where it is desirable to provide, among other things, improved control during adjustment of the support structure, or enhanced stability of the support structure when adjusted.

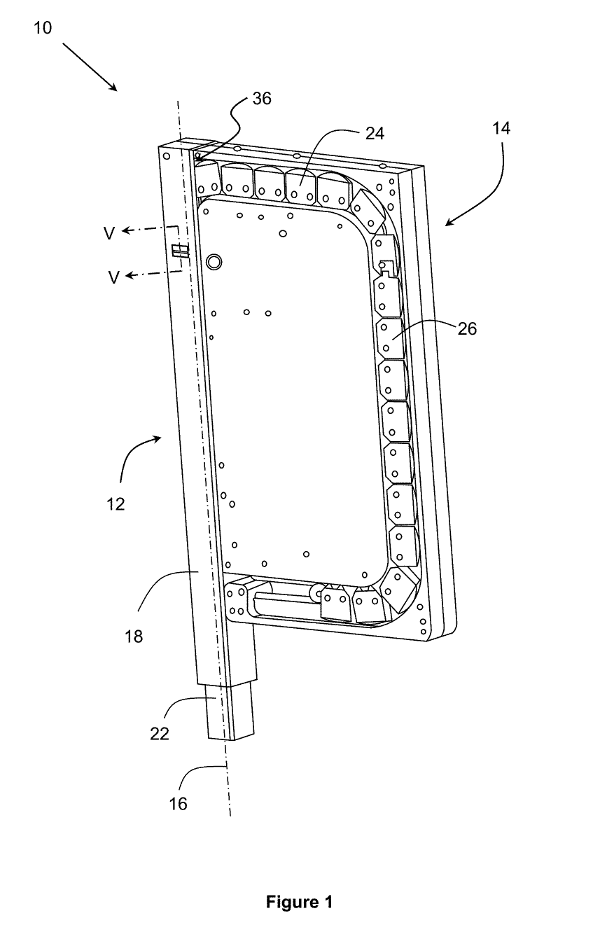

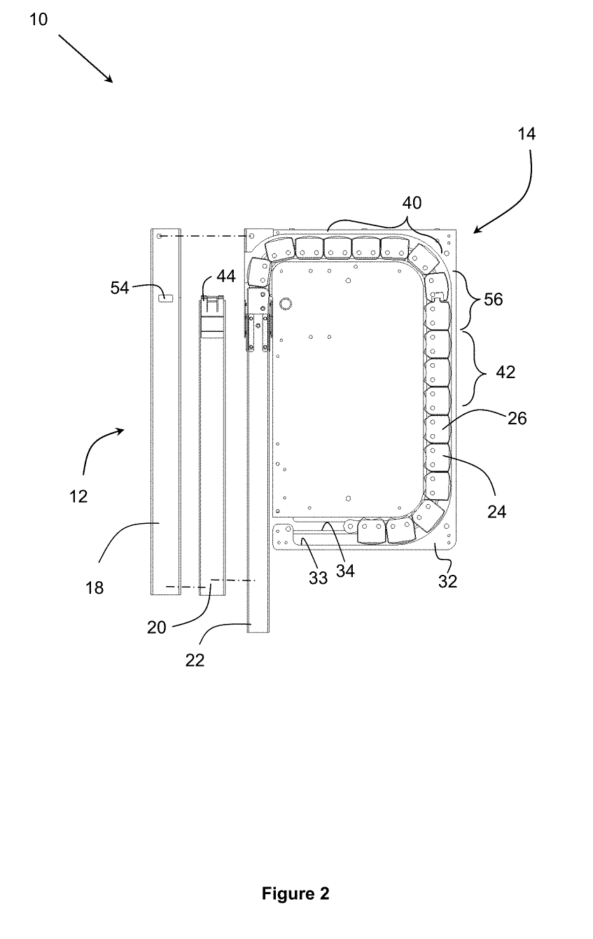

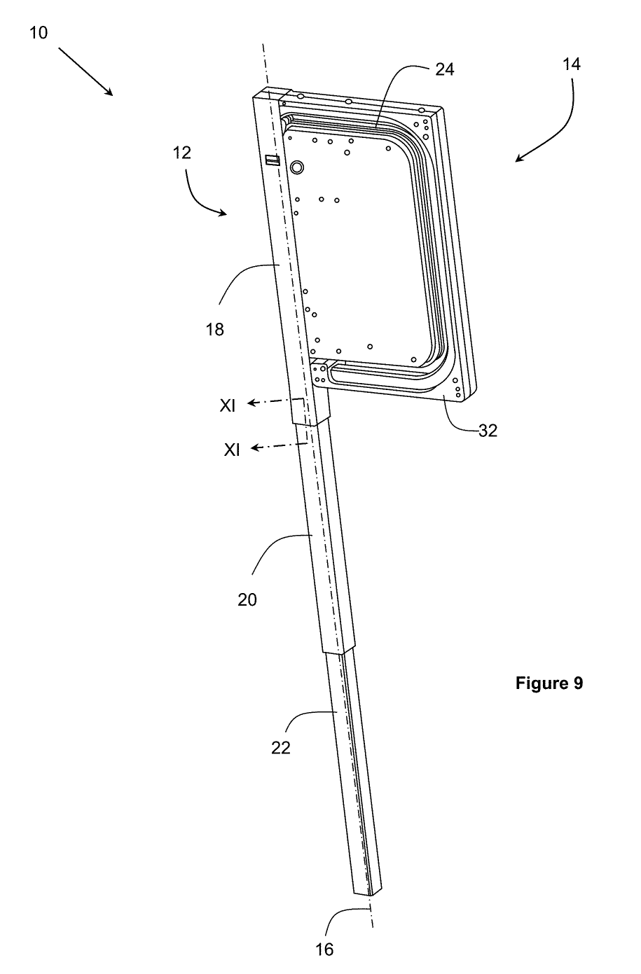

Turning to FIGS. 1 and 2, an exemplary adjustable support structure 10 is shown. The adjustable support structure 10 includes a telescoping assembly 12 and a drive mechanism 14. The drive mechanism 14 is drivingly coupled to the telescoping assembly 12 for moving the telescoping assembly 12 along a longitudinal axis 16 between a first axial position, in which the telescoping assembly 12 is telescopically collapsed (as shown in FIG. 1, for example), and a second axial position, in which the telescoping assembly is telescopically extended (as shown in FIG. 9, for example). The drive mechanism 14 and/or the telescoping assembly 12 may be operably coupled to a platform or frame (not shown), such as for a table, desk, stage, or the like, and the longitudinal movement of the telescoping assembly 12 by the drive mechanism 14 may raise or lower the platform as the telescoping assembly extends or collapses.

The telescoping assembly 12 may include an outer (e.g., upper) support member 18, an intermediate (e.g., middle) support member 20, and an inner (e.g., lower) support member 22. Each of the support members 18 and 20 may have an internal surface that defines an internal passage configured to slidably receive the radially inward adjacent support member. In this manner, the intermediate support member 20 may be telescopically movable in the outer support member 18, and the inner (e.g., lower) support member 22 may be telescopically movable in the intermediate support member 20. For example, as shown in FIG. 1, when the telescoping assembly 12 is telescopically collapsed, the inner support member 22 is nested within the intermediate support member 20, which is nested within the outer support member 18. When the drive mechanism 14 adjusts the telescoping assembly 12 toward the telescopically extended position (shown in FIG. 9, for example), the respective support members 18, 20, 22 may slidably move relative to adjacent ones of each other to thereby axially extend from each other, as will be discussed in further detail below.

In the illustrated embodiment, the respective support members 18, 20, 22 are shown as generally tubular sleeves having progressively smaller square cross-sections. It is understood, however, that the support members may have other suitable configurations, such as circular cross-sections, which may be selected as desired depending on a particular application. In exemplary embodiments, the innermost support member (e.g., inner support member 22), or at least a portion of the innermost support member, may have a solid cross-section. It is further understood that although three such support members are shown, the exemplary support structure 10 may include two, three, four, or more such support members, which may be selected in a suitable manner as understood by those skilled in the art.

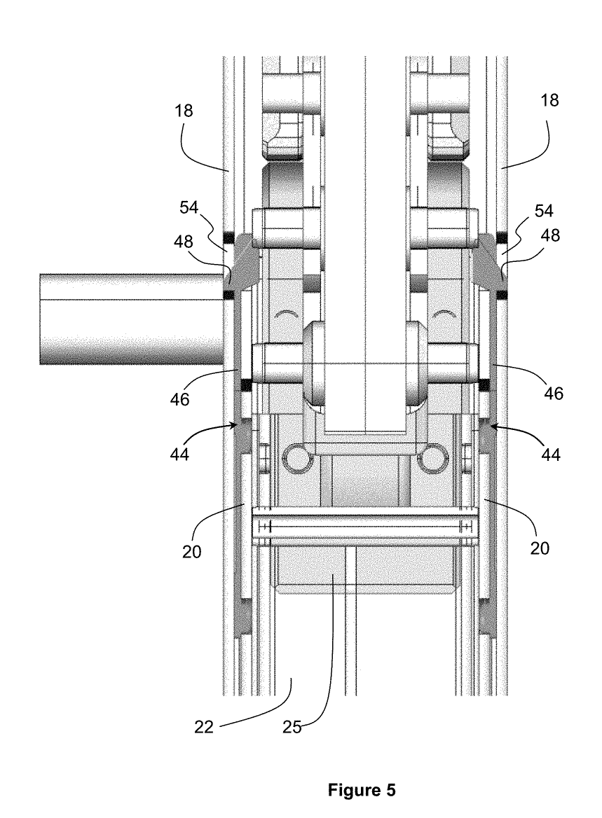

Referring to FIGS. 1-3, the drive mechanism 14 may include a plurality of linkages 24 drivingly coupled to the telescoping assembly 12. In the illustrated embodiment, the linkages 24 form a chain, and an end portion of the chain may be operatively coupled to the inner support member 22. For example, as shown in the cross-sectional view of FIG. 5, an end linkage 25 may be configured as a clevis that is disposed within and operatively coupled to an upper portion of the inner support member 22. It is understood that although the drive mechanism is shown as having linkages 24, other drive mechanisms are possible, such as a belts, other types of chain drives, or other suitable drive mechanism for effecting movement of the telescoping assembly 12.

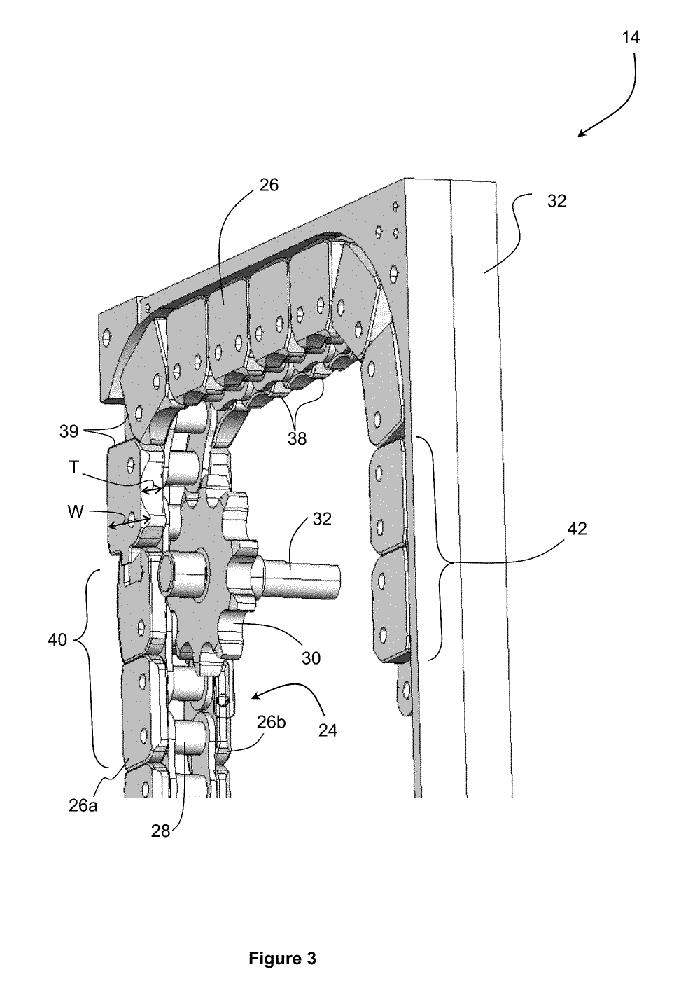

The linkages 24 may include a plurality of bearing members 26 and a plurality of chain links 28. Each bearing member 26 may be pivotally coupled to an adjacent bearing member 26 via one or more of the chain links 28. As shown in FIG. 3, the chain links 28 may be interposed between two bearing members (e.g., 26a, 26b) disposed on opposite sides of a single chain link 28. The chain links 28 may be configured as a roller-type chain link, and may be driven by a sprocket 30 drivingly coupled to a drive shaft 32, which may be drivingly coupled to a motor or other drive (not shown). It is understood that where one or more such support structures 10 are used to raise a platform, for example, each of the supports 10 may have a corresponding motor for independently moving each of the supports; or more than one of the supports 10 may be actuated by a single motor for simultaneous movement with each other.

As the sprocket 30 drives the chain links 28 forward (for extending the telescoping assembly 12) or in reverse (for collapsing or retracting the telescoping assembly 12), the linkages 24 may be dispensed from or loaded into a magazine 32. In the illustrated embodiment, the magazine 32 is configured as plate that houses the sprocket 30, but other configurations are possible, such as a spool, or other suitable configuration. The magazine 32 may include a first track 33 for guiding the bearing members 26, and a second track 34 for guiding the chain links 26. The tracks 33, 34 may curve around the magazine 32 for enhancing compactness.

As will be discussed in further detail below, as the bearing members 26 are dispensed from the magazine 32, they may travel inside of the telescoping assembly 12, such as via passing through a slot or aperture 36 in the outer support member 18. As shown in the illustrated embodiment, the bearing members 26 may be configured as plates having generally flat outward surfaces and a peripheral edge. The bearing members 26 may be configured with rounded peripheral edge portions 38 for smoothly engaging and wrapping around the bearing member track 33, and for being slidably received within the respective support member of the telescoping assembly 12. The bearing members 26 also may have flat edge portions 39 that are configured to engage adjacent bearing members 26. In this manner, when adjacent bearing members 26 are axially aligned, such as when disposed within the telescoping assembly 12, the bearing members 26 may assist in bearing at least a portion of the load on the support structure 10.

The bearing members 26 may be substantially the same as each other, or they may have different configurations. For example, since the respective support members 18, 20, 22 may have progressively smaller cross-sections, the bearing members 26 may be configured in different sizes to fit within a corresponding support member. For example, the bearing members 26 may have a first group 40 that is adapted to fit within the intermediate support member 20, and may have a second group 42 that is adapted to fit within the outer support member 18. The outer support member 18 has a larger cross-section than the intermediate support member 20, and so the second group 42 of bearing members may have a larger lateral width (W) than the lateral width of the first group 40. The second group 42 of bearing members may also have a larger thickness (T) than the first group 40. It is understood that although only two groups 40, 42 of bearing members 26 are shown, more than two groups having different configurations are possible, or groups may be intermixed, or have varying configurations within each group, as desired for the particular application.

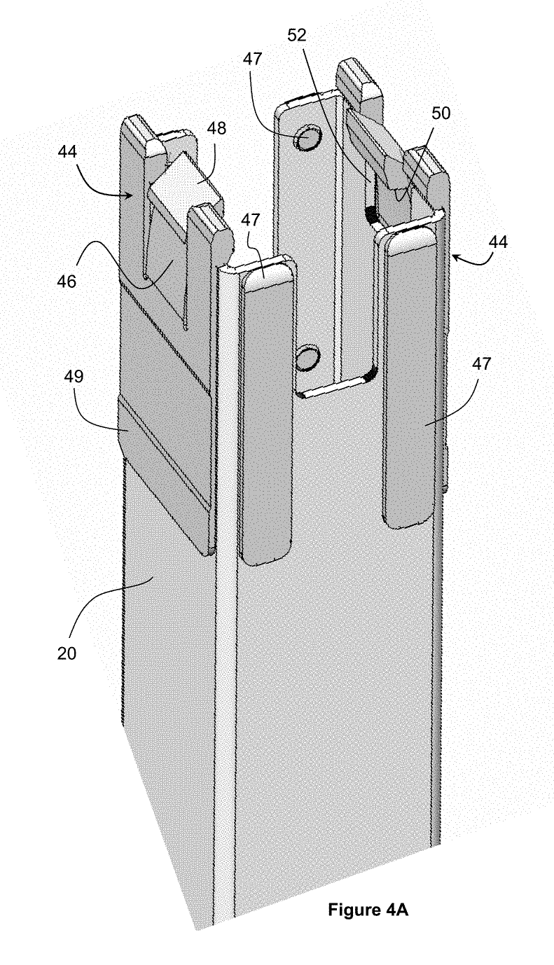

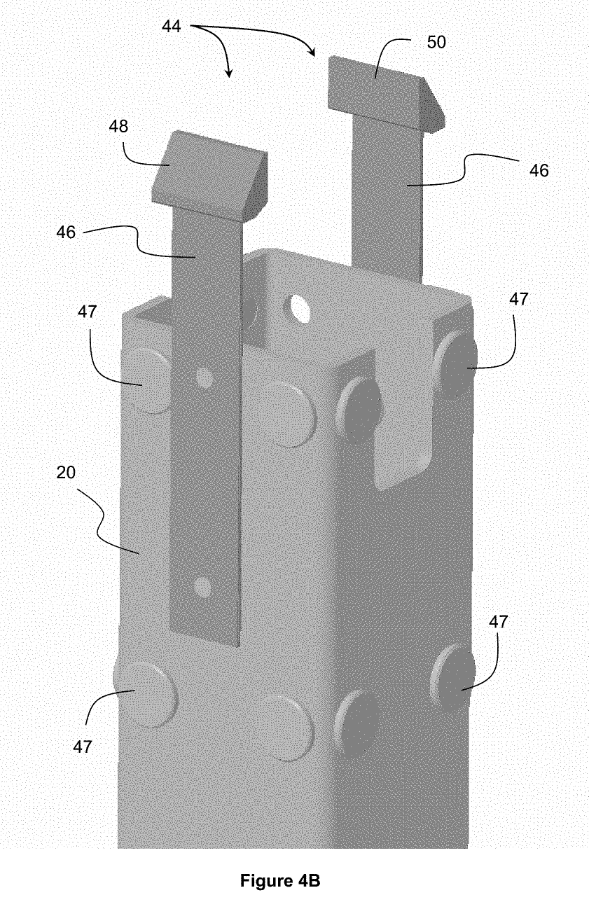

Referring to FIG. 4A, the telescoping assembly 12 may include at least one latching mechanism 44. The latching mechanism 44 may be operatively coupled to the intermediate support member 20 for common movement therewith. In the illustrated embodiment, two of the same latching mechanisms 44 are disposed on opposite sides of the intermediate support member 20. The latching mechanism 44 may have a movable latch 46, such as a lever or other suitable latch, for engaging one or more components of the support structure 10, as will be discussed in further detail below. The latch 46 may have a radially outward abutment portion 48, which may include a ramped surface, and a radially inward abutment portion 50, which also may include a ramped surface.

The intermediate support member 20 may have a slot or aperture 52 for enabling the latch 46 to freely move radially inwardly or outwardly without interference from the intermediate support member 20. It is understood that although the latching mechanism 44 is shown having a latch 46 configured as a lever movable between a radially outward position (e.g., first position) and radially inward position (e.g., second position), that other suitable latching mechanisms may be utilized, such as a rotational latch, for example. The latch 46 may be integral with the latching mechanism 44 as shown in FIG. 4A, or the latch 46 may be separate. The latch 46 may have an intrinsic spring bias, or a biasing member such as a spring may be utilized. Other suitable configurations of the latching mechanism 44 are also possible, as would be understood by those with skill in the art.

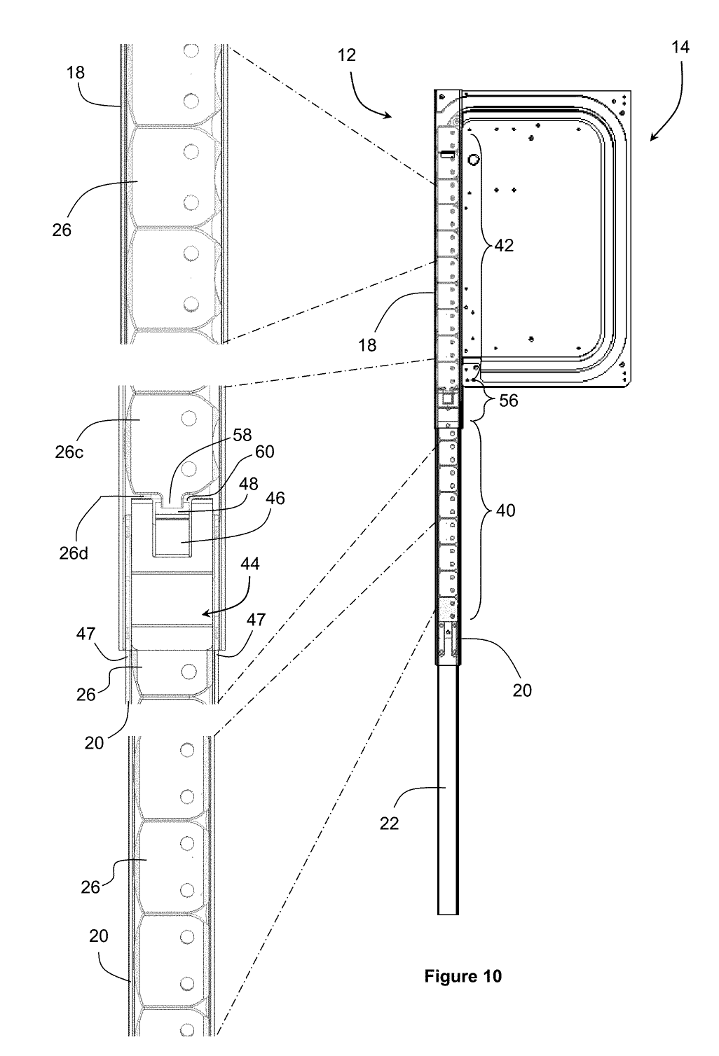

The telescoping assembly 12 may also include at least one bearing pad 47. The bearing pads 47 may be operatively coupled to the intermediate support member 20 for common movement therewith. In the illustrated embodiment of FIG. 4A, two pairs of the same bearing pads 47 are disposed on opposite sides of the intermediate support member 20 on alternative sides of the intermediate support member 20 from the sides on which the latching mechanisms 44 are disposed. The outer surface 49 of the latching mechanism 44 and the bearing pads 47, disposed between the intermediate support member 20 and the internal chamber of the outer support member 18, produce a relatively snug fit between the intermediate support member 20 and the outer support member 18 so as to restrict lateral movement, thus improving stability of the support structure 10 while the support structure 10 supports a load. See FIG. 10.

FIG. 4B illustrates an alternative embodiment to that of FIG. 4A including an alternative intermediate support member 20, latching mechanism 44 and bearing pads 47. The latching mechanism 44 is operatively coupled to the intermediate support member 20 for common movement therewith. In the illustrated embodiment, two of the same latching mechanisms 44 are disposed on opposite sides of the intermediate support member 20. The latching mechanism 44 may have a movable latch 46, such as a lever or other suitable latch, for engaging one or more components of the support structure 10, as will be discussed in further detail below. The latch 46 may have a radially outward abutment portion 48, which may include a ramped surface, and a radially inward abutment portion 50, which also may include a ramped surface.

The intermediate support member 20, instead of having the slot or aperture 52 shown in FIG. 4A, may be shorter for enabling the latch 46 to freely move radially inwardly or outwardly without interference from the intermediate support member 20. The latch 46 may have an intrinsic spring bias, or a biasing member such as a spring may be utilized. Other suitable configurations of the latching mechanism 44 are also possible, as would be understood by those with skill in the art.

The telescoping assembly 12 may also include at least one bearing pad 49. The bearing pads 47 may be operatively coupled to the intermediate support member 20 for common movement therewith. In the illustrated embodiment of FIG. 4B, sixteen of the same bearing pads 47 are used with four bearing pads 47 disposed on each side of the intermediate support member 20. The bearing pads 47, disposed between the intermediate support member 20 and the internal chamber of the outer support member 18, produce a relatively snug fit between the intermediate support member 20 and the outer support member 18 so as to restrict lateral movement, thus improving stability of the support structure 10 while the support structure 10 supports a load.

An exemplary method of operating the support member 10 will now be described in further detail. Referring to FIGS. 1, 2, and 5, the support member 10 is shown in an exemplary collapsed position. In the collapsed state, the latch 46 is movable to its radially outward position for securably engaging the outer support member 18. In the illustrated embodiment, the outer support member 18 defines an aperture 54 that is configured to receive the latch 46, and a portion of the latch abutment 48 engages a wall of the outer support member 18 that defines the aperture 54 to restrict relative movement between the latch 46 and the outer support member 18. The latch 46 being operatively coupled to the intermediate support member 20 thereby restricts axial movement of the intermediate support member 20 relative to the outer support member 18. As used herein, the term “securably engaged” means that the latch restricts relative movement between the listed components.

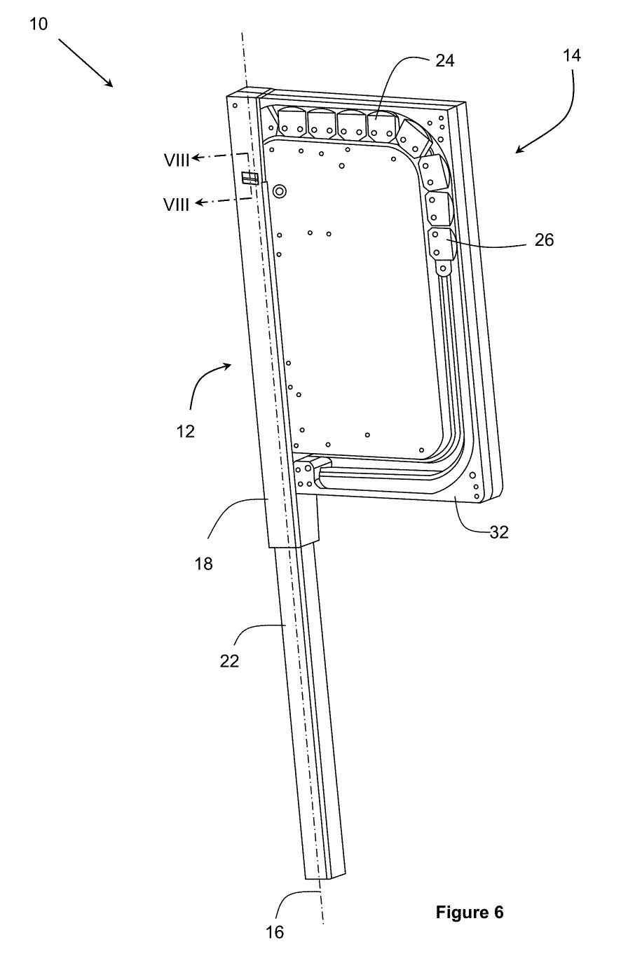

When the telescoping assembly 12 is in the collapsed position (e.g., a first axial position, as shown in FIG. 1, for example) and the latch 46 is in its radially outward position to engage the outer support member 18 (as shown in FIG. 5, for example), the latch 46 also may be releasably disengaged from the inner support member 22 to allow the drive mechanism 14 to axially move the inner support member 22 relative to the intermediate support member 20. Thus, as used herein, the term “releasably disengaged” means that the latch permits relative movement between the listed components, even if the latch may still contact or engage one or more of those components. In such a way, the inner support member 22 may be moved axially to telescopically extend from the intermediate support member 20, such that the telescoping assembly 12 is adjusted to an intermediate position between the collapsed position and extended position (as shown in FIG. 6, for example, understanding that various intermediate positions are possible).

Referring to FIGS. 6-8, the support member 10 is shown in an exemplary intermediate position. As shown when comparing FIG. 6 to FIG. 1, the drive mechanism 14 moves the linkages 24 from the magazine 32 into the telescoping assembly 12, and the inner support member 22 (being releasably disengaged from the latch 46 and thus the intermediate support member 20) moves independently of the intermediate support member 20 to telescopically extend away from the intermediate support member 20.

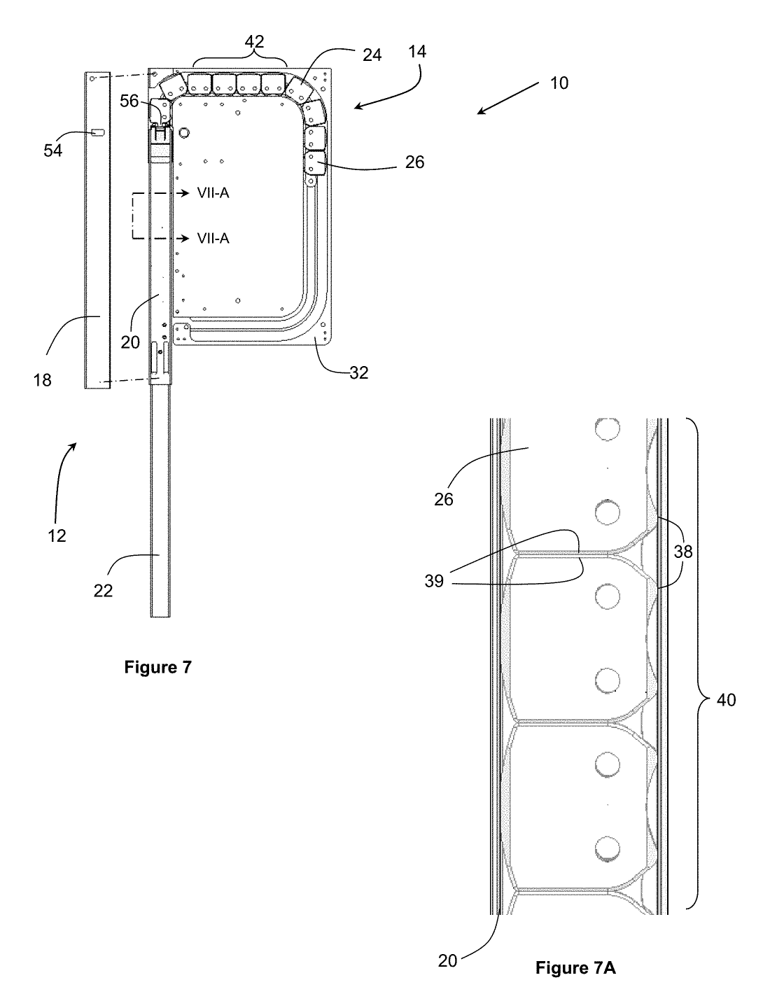

As shown in FIGS. 7 and 7A, the first group 40 of bearing members 26 are adapted to fit within the intermediate support member 20. More particularly, one or more of the bearing members 26 of the first group 40 may be configured to fit within the intermediate support member 20 so as to restrict lateral movement of the bearing member 26. For example, the bearing members 26 of the first group 40 may have a lateral width that is only slightly less than the corresponding lateral width of the internal chamber of the intermediate support member 20, for example, about 0.001 inches to about 0.050 inches less, or about 0.005 in., 0.010 in., 0.020 in., or 0.040 inches less.

In the illustrated intermediate state, the support structure 10 can support a load with at least a portion of the load being supported by the inner support member 22. In addition, at least a portion of the load may be supported by the first group 40 of bearing members 26 that are axially aligned within the intermediate support member 20, and thereby engage each other on respective edge portions 39. This supporting function of the bearing members 26 also enables the support structure 10 to support a load at various positions between the collapsed position and intermediate position. In addition, while supporting such a load, the first group 40 of bearing members 26 may have a relatively snug fit within the intermediate support structure 20 so as to restrict lateral movement, thus improving stability of the support structure 10.

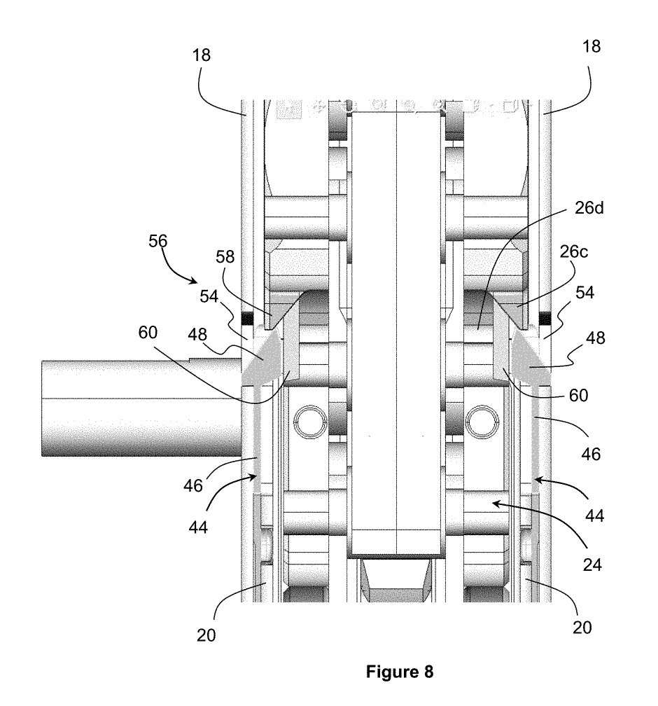

Referring to FIG. 8, the drive mechanism 14 also may include a catch mechanism 56 that is operable to move the latch 46 between its securably engaged position and its releasably disengaged position. As shown, the catch mechanism 56 may be formed from one or more of the linkages 24, and may thus be operably coupled via other linkages 24 to the inner support member 22. In this manner, the catch mechanism 56 may be an independent component from the respective support members. In the illustrated embodiment, the catch mechanism 56 is formed from two adjacent bearing catch members 26c and 26d. As shown, the first bearing catch member 26c may be part of the second group 42 of bearing members, and the second bearing catch member 26d may be part of the first group 40 of bearing members. Also as shown, the first bearing catch member 26c may have a protrusion 58 configured to engage the radially outward abutment portion 48 of the latch 46. The second bearing catch member 26d may have a recess 60 opposing the protrusion 58 of the first bearing catch member 26c, and the recess 60 may be configured to receive the latch 46, as discussed in further detail below.

As the telescoping assembly 12 continues to telescopically extend from the intermediate position as shown in FIG. 8, the catch mechanism 56 engages the latch 46, thereby unlatching the intermediate support member 20 from the outer support member 18 and enabling relative axial movement between the support members 18, 20. More particularly, as the drive mechanism 14 continues to drive the linkages 24 toward the extend position, the catch mechanism protrusion 58 engages the latch 46 to thereby urge the latch 46 toward its radially inward position where it can be received in the catch mechanism recess 60. When the latch 46 is moved to its radially inward position in this way, the latch 46 releasably disengages from the aperture wall defined by the outer support member 18, thereby allowing axial movement of the intermediate support member 20 relative to the outer support member 18.

After the latch 46 has been unlatched from the outer support member 18, the drive mechanism 14 may move the intermediate support member 20 to telescopically extend away from the outer support member 18 (e.g., toward the telescopically extended position as shown in FIG. 9, for example). For example, as shown in the illustrated embodiment of FIG. 8, the catch mechanism protrusion 58 engages the latch 46 to urge it radially inwardly to the unlatched position, and also exerts an axial force to the latch 46. The catch mechanism protrusion 58 may have a radially inward ramped surface that is complimentary to the ramped surface of the radially outward latch abutment 48 for facilitating both the radially inward force and the axial force exerted by the catch mechanism 56 to the latch 46.

Since the latch 46 is operably coupled to the intermediate support member 20, the intermediate support member 20 moves axially in response to the force exerted by the catch mechanism 56 to the latch 46. In addition, because the inner support member 22 is operably coupled to the catch mechanism 56 via linkages 24, the inner support member 22 also moves axially as the catch mechanism 56 moves the intermediate support member 20 with the latch 46. In this manner, as the telescoping assembly 12 extends from the intermediate position (as shown in FIG. 6, for example) toward the extended position (as shown in FIG. 9, for example), the latch 46 may cooperate with the catch mechanism 56 to restrict relative movement between the intermediate support member 20 and the inner support member 22, such that the support members 20, 22 may move together toward the extended position.

Referring to FIGS. 9-11, the support member 10 is shown in an exemplary telescopically extended position. As shown when comparing FIG. 9 to FIG. 6, the drive mechanism 14 continues to move the linkages 24 from the magazine 32 into the telescoping assembly 12, and the intermediate support member 20 moves with the inner support member 22 to telescopically extend away from the outer support member 18, as discussed above.

As shown in FIG. 10, the first group 40 of bearing members 26 are still disposed within the intermediate support member 20. In addition, the second group 42 of bearing members 26 may be adapted to fit within the outer support member 18. More particularly, one or more of the bearing members 26 of the second group 42 may be configured to fit within the outer support member 18 so as to restrict lateral movement of the bearing members 26. For example, the bearing members 26 of the second group 42 may have a lateral width that is only slightly less than the corresponding lateral width of the internal chamber of the outer support member 18, for example, about 0.001 inches to about 0.050 inches less, or about 0.005 in., 0.010 in., 0.020 in., or 0.040 inches less. As discussed above, the second group 42 of bearing members may have a lateral width that is greater than the lateral width of the first group 40 of bearing members to accommodate for the greater lateral width of the outer support member 18 relative to the intermediate support member 20.

It is also noted that the respective bearing members (e.g., 26a, 26b) on opposite sides of the chain links 28 may be sufficiently spaced apart to accommodate for lateral load in the direction of the thickness of the bearing members 26. As discussed above, the second group 42 of bearing members may have a thickness that is greater than the thickness of the first group 40 of bearing members, which may accommodate for the greater width of the outer support member 18 relative to the intermediate support member 20.

Such a configuration enables the support structure 10 to support a load with at least a portion of the load being supported by both the intermediate support member 20 and the inner support member 22. In addition, at least a portion of the load may be supported by both the first group 40 and second group 42 of bearing members 26 that are axially aligned within the intermediate support member 20 and outer support member 18, respectively. The bearing members of the second group 42 may be configured to engage each other on respective edge portions 39 when they are axially aligned within the outer support structure 18, and this supporting function of the bearing members 26 may enable the support structure 10 to support a load at various positions between the intermediate position and telescopically extended position. In addition, while supporting such a load, the second group 42 of bearing members 26 may have a relatively snug fit within the outer support structure 18 so as to restrict lateral movement, thus improving stability of the support structure 10 in the extended position.

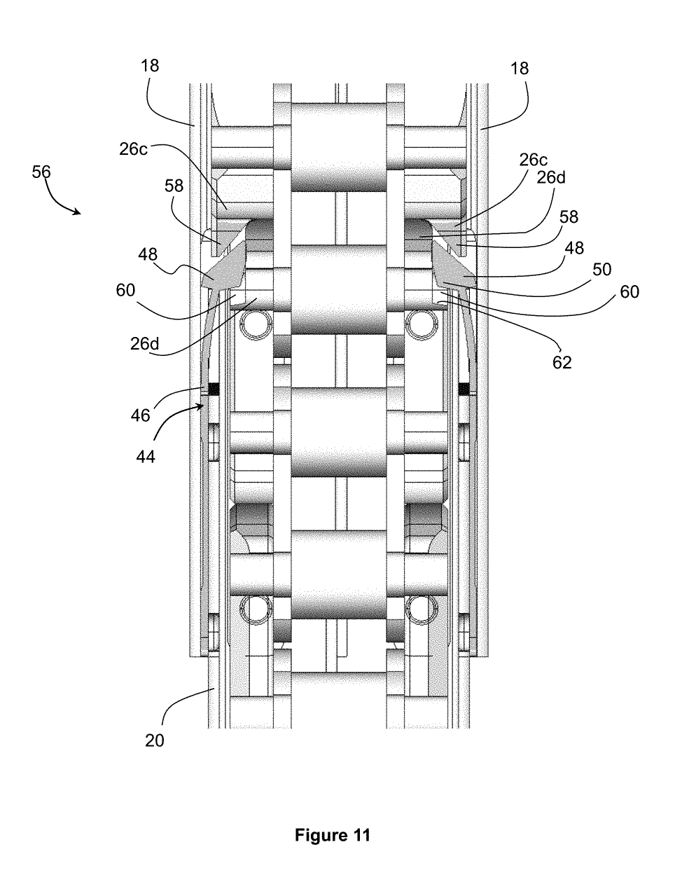

Referring to FIG. 11, a cross-sectional view shows the catch mechanism 56 cooperating with the latch mechanism 44 when the telescoping assembly is moved from the telescopically extended position (shown in FIG. 9, for example) toward the intermediate position (shown in FIG. 6, for example) or the collapsed position (shown in FIG. 1, for example). As shown in the illustrated embodiment, the recess 60 of the catch mechanism 56 receives the latch 46, and the catch mechanism recess 60 has an abutment 62 configured to engage the radially inward abutment portion 50 of the latch 46. When the driving mechanism 14 moves the catch mechanism 56 back toward the intermediate position or the collapsed position, the recess abutment 62 engages the latch abutment 50 and exerts an axial force on the latch 46. Since the latch 46 is operably coupled to the intermediate support member 20, the intermediate support member 20 moves axially toward the collapsed position in response to the force exerted by the recess abutment 62 to the latch 46. In addition, because the inner support member 22 is operably coupled to the catch mechanism 56 via linkages 24, the inner support member 22 moves axially along with the intermediate support member 20 toward the collapsed position.

In exemplary embodiments, the recess abutment 62 also may urge the latch 46 toward its radially outward position. The latch 46 may be constrained by the radially inner surface of the outer support member 18 when the telescoping assembly is in a position between the intermediate position and the extended position, where such constraint maintains the latch 46 in its radially inward position engaged with the recess abutment 62. In exemplary embodiments, the recess abutment 62 may have a ramped surface that is complimentary to a ramped surface of the radially inward abutment portion 50 of the latch, which may facilitate both the radially outward force and the axial force exerted by the catch mechanism 56 to the latch 46 when moving toward the collapsed position.

When the telescoping assembly 12 is at the intermediate axial position (as shown in FIG. 6, for example), the latch 46 may be free to move radially outwardly through the aperture 54 in the outer support member 18. The latch 46 may thereby securably engage the outer support member 18 and thereby restrict axial movement of the intermediate support member 20 relative to the outer support member 18. When the latch 46 moves to its radially outward position in this way, the latch 46 releasably disengages from the catch mechanism 56, thereby enabling the inner support member 22 to move independently of the intermediate support member 20 and the outer support member 18. The drive mechanism 14 may continue to move the inner support member 22 to the collapsed position (as shown in FIG. 1, for example).

The drive mechanism 14 may move the telescoping assembly 12 back and forth to various positions between the telescopically collapsed position and extended position in the manner(s) described above so as to raise or lower a platform, or the like, while supporting a load. Such exemplary configuration(s) of the support structure 10 may enable improved control during the adjustment, and may enhance the stability of the support structure.

It is understood that exemplary embodiments of the adjustable support structure can be implemented in combination with digital electronic circuitry, or computer software, firmware, or hardware, such as for utilizing the drive mechanism and/or adjusting the various positions of adjustable support. In exemplary embodiments, an adjustable support structure as described herein may use one or more modules of computer program instructions encoded on a computer-readable medium for execution by, or to control the operation of, data processing apparatus. The computer-readable medium can be a manufactured product, such as non-transitory computer readable medium, for example a hard drive in a computer system. A controller may be used, which includes all apparatus, devices, and machines for processing data, including by way of example a programmable processor or a computer. A computer program (also known as software or code) can be written in any form of programming language and it can be deployed in any form, including as a stand-alone program or as a module, component, subroutine, or other unit suitable for use in a computing environment. To provide for interaction with a user, an exemplary support structure can be implemented using a computer having a display device, e.g., an LED (light emitting diode) display monitor, for displaying information to the user, and a keyboard or touch panel or pointing device, e.g., a mouse, by which the user can provide input to the computer.

As described herein an exemplary adjustable support structure may have a telescoping assembly that is movable by a drive mechanism between a collapsed position and an extended position.

The telescoping assembly may include a latching mechanism that cooperates with one or more telescopic support members to permit or restrict movement of one or more support members relative to each other as the telescoping assembly is collapsed or extended.

The drive mechanism may include linkages and a catch mechanism configured to cooperate with the latching mechanism for permitting or restricting relative movement between support members, and which may enable sequential telescopic extension or retraction of the support members.

The linkages may be adapted to fit within one or more of the telescopic support members, such that the linkages may support a portion of the load, and may enhance stability by restricting lateral movement within the support members.

According to an aspect, an adjustable support structure includes a telescoping assembly extending along a longitudinal axis, the telescoping assembly including an outer support member, an intermediate support member telescopically movable in the outer support member, an inner support member telescopically movable in the intermediate support member, and a latching mechanism operatively coupled to the intermediate support member. The latching mechanism may have a latch movable between a first position for securably engaging the outer support member, and a second position for releasably disengaging from the outer support member. The adjustable support structure may further include a drive mechanism drivingly coupled to the telescoping assembly for moving the telescoping assembly along the longitudinal axis between a first axial position, in which the telescoping assembly is telescopically collapsed and the latch is in its first position thereby securably engaging the outer support member for restricting axial movement of the intermediate support member relative to the outer support member, and a second axial position, in which the telescoping assembly is telescopically extended and the latch is in its second position thereby releasably disengaging from the outer support member for allowing axial movement of the intermediate support member relative to the outer support member.

Embodiments of the invention may include one or more of the following additional features, alone or in combination.

For example, the drive mechanism may be operably coupled to the inner support member.

When the telescoping assembly is in the first axial position and the latch is in its first position, the latch may be releasably disengaged from the inner support member to allow the drive mechanism to axially move the inner support member relative to the intermediate support member, such that the telescoping assembly is movable toward the second position, for example.

When the telescoping assembly is at an intermediate axial position between the first axial position and the second axial position, and the latch is in its second position, the latch may be operable to restrict axial movement of the intermediate support member relative to the inner support member, thereby enabling the intermediate support member to move axially with the inner support member as the telescoping assembly is moved from the intermediate axial position toward the second axial position, or is moved from the second axial position toward the intermediate axial position

The inner support member may be operably coupled to a catch mechanism.

When the telescoping assembly is at an intermediate axial position between the first axial position and the second axial position, the catch mechanism may be operable to move the latch to its second position, thereby enabling relative axial movement between the outer support member and the intermediate support member, and thereby restricting relative axial movement between the intermediate support member and the inner support member such that the intermediate support member moves axially with the inner support member as the telescoping assembly is moved from the intermediate axial position toward the second axial position, or is moved from the second axial position toward the intermediate axial position.

The catch mechanism may have a protrusion configured to engage a radially outward portion of the latch, such that, when the telescoping assembly is moved from the intermediate axial position toward the second axial position the catch mechanism protrusion may urge the latch toward its radially inward position thereby releasably disengaging the latch from the outer support member and enabling relative axial movement between the intermediate support member and the outer support member, and/or the catch mechanism protrusion may exert a force via the latch and/or latching mechanism to axially move the intermediate support member with the inner support member, such that the telescoping assembly moves toward the second axial position, for example.

The catch mechanism may have a recess configured to receive the latch when the latch is in its radially inward position, the catch mechanism recess having an abutment configured to engage a radially inward portion of the latch, such that, when the telescoping assembly is moved toward the intermediate axial position from the second axial position, the recess abutment may exert a force via the latch and/or the latching assembly to axially move the intermediate support member with the inner support member such that the telescoping assembly moves toward the intermediate axial position, for example.

When the telescoping assembly is moved toward the intermediate axial position from the second axial position, the recess abutment may urge the latch toward its radially outward position, the latch being constrained by a radially inner surface of the outer support member to maintain the latch in its radially inward position.

When the telescoping assembly is at the intermediate axial position, the latch may be free to move radially outwardly through an aperture in the outer support member to securably engage a portion of the outer support member and thereby restrict axial movement of the intermediate support member relative to the outer support member.

The latch may be configured as a lever.

The drive mechanism may include a plurality of linkages drivingly coupled to the inner support member.

The catch mechanism may be at least one of the plurality of linkages.

The catch mechanism may include a first linkage having a protrusion for engaging the latch, and a second adjacent linkage having a recess for receiving the latch.

According to another aspect, an adjustable support structure includes a telescoping assembly extending along a longitudinal axis, the telescoping assembly including an outer support member; an intermediate support member telescopically movable in the outer support member; and an inner support member telescopically movable in the intermediate support member; and a drive mechanism drivingly coupled to the telescoping assembly for moving the telescoping assembly along the longitudinal axis between a first axial position, in which the telescoping assembly is telescopically collapsed, and a second axial position, in which the telescoping assembly is telescopically extended. The drive mechanism may include a plurality of linkages drivingly coupled to the inner support member, the plurality of linkages being configured to slidably move within one or more of the outer support member and the intermediate support member when the telescoping assembly is axially moved between the first axial position and the second axial position.

The plurality of linkages may include at least one first linkage adapted to fit within the intermediate support member for restricting lateral movement of the at least one first linkage when disposed in the intermediate support member.

The plurality of linkages may include at least one second linkage adapted to fit within the outer support member for restricting lateral movement of the at least one second linkage when disposed in the outer support member.

The plurality of linkages may include a plurality of bearing members, the plurality of bearing members being configured to slidably move within one or more of the outer support member and the intermediate support member when the telescoping assembly is axially moved between the first axial position and the second axial position.

Adjacent bearing members of the plurality of bearing members may be configured to engage one another, such that, when at least a portion of the plurality of bearing members are axially aligned within the outer support member and/or the intermediate support member, the portion of axially aligned bearing members supports at least some of a load exerted on the adjustable support.

In some embodiments, the bearing members may be pivotally coupled to each other via one or more chain links.

The chain links may be driven by a sprocket.

The plurality of linkages may be dispensed from a magazine when the telescoping assembly is moved from the first axial position toward the second axial position.

The plurality of linkages may be received in the magazine when the telescoping assembly is moved from the second axial position toward the first axial position.

According to another aspect, a method of adjusting an adjustable support structure having a drive mechanism operably coupled to a telescoping assembly, the telescoping assembly including an outer support member, an intermediate support member telescopically movable in the outer support member, and an inner support member telescopically movable in the intermediate support member, the method including one or more of the following steps alone or in combination:

(i) when the telescoping assembly is in a telescopically collapsed position, latching the intermediate support member to the outer support member with a latching mechanism operably attached to the intermediate support member, whereby the latching restricts axial movement of the intermediate support member relative to the outer support member;

(ii) moving the inner support member independent of the intermediate support member and the outer support member, wherein the inner support member is moved with the drive mechanism such that the inner support member telescopically extends in an axial direction away from the intermediate support member and the outer support member;

(iii) moving a catch mechanism with the drive mechanism, the catch mechanism being independent from the respective support members;

(iv) engaging the latching mechanism with the catch mechanism, thereby unlatching the intermediate support member from the outer support member and enabling axial movement of the intermediate support member relative to the outer support member;

(v) after the unlatching, moving the intermediate support member independent of the outer support member, wherein the intermediate support member is moved with the drive mechanism such that the intermediate support member telescopically extends in the axial direction away from the outer support member, the intermediate support member being moved with the catch mechanism via the latch mechanism operably attached to the intermediate support member;

(vi) during the moving the intermediate support member, moving the inner support member with the drive mechanism such that the inner support member moves with the intermediate support member;

(vii) when the telescoping assembly is in a telescopically extended position, moving the intermediate support member with the drive mechanism toward the telescopically collapsed position, wherein the intermediate support member is moved with the catch mechanism via the latch mechanism operably attached to the intermediate support member, and wherein the intermediate support member is moved independent of the outer support member;

(viii) during the moving the intermediate support member, moving the inner support member with the drive mechanism such that the inner support member moves with the intermediate support member toward the collapsed position;

(ix) disengaging the catch mechanism from the latching mechanism;

(x) latching the intermediate support member to the outer support member with the latching mechanism, whereby the latching restricts axial movement of the intermediate support member relative to the outer support member; and

(xi) moving the inner support member independent of the intermediate support member and the outer support member, wherein the inner support member is moved with the drive mechanism toward the telescopically collapsed position.

In some embodiments, the method may further include one or more of the steps: (xii) during the moving the inner support member from the telescopically collapsed position toward the telescopically extended position, moving a portion of the plurality of linkages to within the intermediate support member, whereby the portion of linkages disposed within the intermediate support member are axially aligned to support a load, and engage the intermediate support member to laterally constrain movement of the portion of linkages disposed in the intermediate support member; and (xiii) during the moving the intermediate support member toward the telescopically extended position, moving another portion of the plurality of linkages to within the outer support member, whereby the portion of linkages disposed within the outer support member are axially aligned to support a load, and engage the outer support member to laterally constrain movement of the portion of linkages disposed in the outer support member.

As used herein, the terms “upper”, “lower”, “top”, “bottom,” “front,” “rear,” “inner,” “outer,” “left,” “right,” “above,” “below,” and the like as used in this disclosure should be understood as referring to an arbitrary frame of reference, for example viewing an exemplary adjustable support structure in a horizontal position as shown in FIG. 1, rather than to the ordinary gravitational frame of reference. This is done realizing that these units can be mounted on the top, bottom, or sides of other components, or can be inclined with respect to a platform, or can be provided in various other positions.

As used herein, an “operable connection” or “operable coupling,” or a connection by which entities are “operably connected” or “operably coupled” is one in which the entities are connected in such a way that the entities may perform as intended. An operable connection may be a direct connection or an indirect connection in which an intermediate entity or entities cooperate or otherwise are part of the connection or are in between the operably connected entities.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both,” and thus “or” as used herein is the inclusive, and not the exclusive use. When intended to indicate “only A or B but not both” then the term “only A or B but not both” will be employed.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An adjustable support structure, comprising:
a telescoping assembly extending along a longitudinal axis, including:
an outer support member;
an intermediate support member telescopically movable in the outer support member;
an inner support member telescopically movable in the intermediate support member; and
a latching mechanism operatively coupled to the intermediate support member, the latching mechanism having a latch movable between a first position for securably engaging the outer support member, and a second position for releasably disengaging from the outer support member; and
a drive mechanism drivingly coupled to the telescoping assembly for moving the telescoping assembly along the longitudinal axis between a first axial position, in which the telescoping assembly is telescopically collapsed and the latch is in its first position thereby being securably engaged with the outer support member for restricting axial movement of the intermediate support member relative to the outer support member, and a second axial position, in which the telescoping assembly is telescopically extended and the latch is in its second position thereby being releasably disengaged from the outer support member for allowing axial movement of the intermediate support member relative to the outer support member.

2. The adjustable support structure according to claim 1, wherein the drive mechanism is operably coupled to the inner support member; and
wherein, when the telescoping assembly is in the first axial position and the latch is in its first position, the latch is releasably disengaged from the inner support member to allow the drive mechanism to axially move the inner support member relative to the intermediate support member.

3. The adjustable support structure according to claim 1, wherein, when the telescoping assembly is at an intermediate axial position between the first axial position and the second axial position, and the latch is in its second position, the latch is operable to restrict axial movement of the intermediate support member relative to the inner support member, thereby enabling the intermediate support member to move axially with the inner support member as the telescoping assembly is moved from the intermediate axial position toward the second axial position, or is moved from the second axial position toward the intermediate axial position.

4. The adjustable support structure according to claim 1, wherein the inner support member is operably coupled to a catch mechanism;
wherein, when the telescoping assembly is at an intermediate axial position between the first axial position and the second axial position, the catch mechanism is operable to move the latch to its second position, thereby enabling relative axial movement between the outer support member and the intermediate support member, and thereby restricting relative axial movement between the intermediate support member and the inner support member such that the intermediate support member moves axially with the inner support member as the telescoping assembly is moved from the intermediate axial position toward the second axial position, or is moved from the second axial position toward the intermediate axial position.

5. The adjustable support structure according to claim 1, wherein the latch is configured as a lever, the lever being movable between a radially outward position corresponding with the first position of the latch, and a radially inward position corresponding with the second position of the latch.

6. The adjustable support structure according to claim 4, wherein the catch mechanism has a protrusion configured to engage a radially outward portion of the lever, such that, when the telescoping assembly is moved from the intermediate axial position toward the second axial position:
the catch mechanism protrusion urges the lever toward its radially inward position thereby releasably disengaging the lever from the outer support member and enabling relative axial movement between the intermediate support member and the outer support member, and
the catch mechanism protrusion exerts a force via the lever and latching mechanism to axially move the intermediate support member with the inner support member.

7. The adjustable support structure according to claim 6, wherein the catch mechanism has a recess opposing the protrusion, the recess being configured to enable the lever to be moved toward its radially inward position when being urged radially inwardly by the protrusion.

8. The adjustable support structure according to claim 6, wherein the catch mechanism has a recess configured to receive the lever when the lever is in its radially inward position, the catch mechanism recess having an abutment configured to engage a radially inward portion of the lever, such that, when the telescoping assembly is moved toward the intermediate axial position from the second axial position, the recess abutment exerts a force via the lever and the latching assembly to axially move the intermediate support member with the inner support member such that the telescoping assembly moves toward the intermediate axial position.

9. The adjustable support structure according to claim 8, wherein, when the telescoping assembly is moved toward the intermediate axial position from the second axial position, the recess abutment urges the lever toward its radially outward position, the lever being constrained by a radially inner surface of the outer support member to maintain the lever in its radially inward position; and
wherein, when the telescoping assembly is at the intermediate axial position, the lever is free to move radially outwardly through an aperture in the outer support member to securably engage a portion of the outer support member and thereby restrict axial movement of the intermediate support member relative to the outer support member.

10. The adjustable support structure according to claim 4, wherein the drive mechanism includes a plurality of linkages drivingly coupled to the inner support member, and wherein the catch mechanism is at least one of the plurality of linkages.

11. The adjustable support structure according to claim 10, wherein the catch mechanism includes a first linkage having a protrusion for engaging the latch, and a second adjacent linkage having a recess for receiving the latch.

12. The adjustable support structure according to claim 10, wherein the plurality of linkages includes a plurality of bearing members, the plurality of bearing members being configured to slidably move within one or more of the outer support member and the intermediate support member when the telescoping assembly is axially moved between the first axial position and the second axial position; and
wherein adjacent bearing members of the plurality of bearing members are configured to engage one another, such that, when at least a portion of the plurality of bearing members are axially aligned within the outer support member and/or the intermediate support member, the portion of axially aligned bearing members supports at least some of a load exerted on the adjustable support.

13. The adjustable support structure according to claim 12, wherein the plurality of bearing members includes a first plurality of bearing members adapted to fit within the intermediate support member for restricting lateral movement of the first plurality of bearing members when the bearing members are disposed in the intermediate support member; and
wherein the plurality of bearing members includes a second plurality of bearing members adapted to fit within the outer support member for restricting lateral movement of the second plurality of bearing members when disposed in the outer support member.

14. The adjustable support structure according to claim 12, wherein the bearing members are configured as bearing members, the bearing members being pivotally coupled to each other via one or more chain links, and wherein the chain links are driven by a sprocket.

15. The adjustable support structure according to claim 10, wherein the plurality of linkages is dispensable from a magazine when the telescoping assembly is moved from the first axial position toward the second axial position, and wherein the plurality of linkages is receivable in the magazine when the telescoping assembly is moved from the second axial position toward the first axial position.

16. An adjustable support structure, comprising:
a telescoping assembly extending along a longitudinal axis, including:
an outer support member;
an intermediate support member telescopically movable in the outer support member; and
an inner support member telescopically movable in the intermediate support member; and
a drive mechanism drivingly coupled to the telescoping assembly for moving the telescoping assembly along the longitudinal axis between a first axial position, in which the telescoping assembly is telescopically collapsed, and a second axial position, in which the telescoping assembly is telescopically extended;
wherein the drive mechanism includes a plurality of linkages drivingly coupled to the inner support member, the plurality of linkages being configured to slidably move within one or more of the outer support member and the intermediate support member when the telescoping assembly is axially moved between the first axial position and the second axial position;
wherein the plurality of linkages includes at least one first linkage adapted to fit within the intermediate support member for restricting lateral movement of the at least one first linkage when disposed in the intermediate support member; and
wherein the plurality of linkages includes at least one second linkage adapted to fit within the outer support member for restricting lateral movement of the at least one second linkage when disposed in the outer support member.

17. A method of adjusting an adjustable support structure having a drive mechanism operably coupled to a telescoping assembly, the telescoping assembly including an outer support member, an intermediate support member telescopically movable in the outer support member, and an inner support member telescopically movable in the intermediate support member, the method comprising:
when the telescoping assembly is in a telescopically collapsed position, latching the intermediate support member to the outer support member with a latching mechanism operably attached to the intermediate support member, whereby the latching restricts axial movement of the intermediate support member relative to the outer support member;
moving the inner support member independent of the intermediate support member and the outer support member, wherein the inner support member is moved with the drive mechanism such that the inner support member telescopically extends in an axial direction away from the intermediate support member and the outer support member;
moving a catch mechanism with the drive mechanism, the catch mechanism being independent from the respective support members; and
engaging the latching mechanism with the catch mechanism, thereby unlatching the intermediate support member from the outer support member and enabling axial movement of the intermediate support member relative to the outer support member.

18. The method according to claim 17, further comprising:
after the unlatching, moving the intermediate support member independent of the outer support member, wherein the intermediate support member is moved with the drive mechanism such that the intermediate support member telescopically extends in the axial direction away from the outer support member, the intermediate support member being moved with the catch mechanism via the latch mechanism operably attached to the intermediate support member; and
during the moving the intermediate support member, moving the inner support member with the drive mechanism such that the inner support member moves with the intermediate support member.

19. The method according to claim 18, further comprising:
when the telescoping assembly is in a telescopically extended position, moving the intermediate support member with the drive mechanism toward the telescopically collapsed position, wherein the intermediate support member is moved with the catch mechanism via the latch mechanism operably attached to the intermediate support member, and wherein the intermediate support member is moved independent of the outer support member;
during the moving the intermediate support member, moving the inner support member with the drive mechanism such that the inner support member moves with the intermediate support member toward the collapsed position;
disengaging the catch mechanism from the latching mechanism;
latching the intermediate support member to the outer support member with the latching mechanism, whereby the latching restricts axial movement of the intermediate support member relative to the outer support member; and
moving the inner support member independent of the intermediate support member and the outer support member, wherein the inner support member is moved with the drive mechanism toward the telescopically collapsed position.

20. The method according to claim 17, wherein the drive mechanism includes a plurality of linkages, the method further comprising one or more of the steps:
during the moving the inner support member from the telescopically collapsed position toward the telescopically extended position, moving a portion of the plurality of linkages to within the intermediate support member, whereby the portion of linkages disposed within the intermediate support member are axially aligned to support a load, and engage the intermediate support member to laterally constrain movement of the portion of linkages disposed in the intermediate support member; and
during the moving the intermediate support member toward the telescopically extended position, moving another portion of the plurality of linkages to within the outer support member, whereby the portion of linkages disposed within the outer support member are axially aligned to support a load, and engage the outer support member to laterally constrain movement of the portion of linkages disposed in the outer support member.
